(19) United States
(12) Patent Application Publication
(10) Pub. No.: US 2013/0280020 A1
(43) Pub. Date: Oct. 24, 2013

(54) HARD TOP REMOVAL HITCH ATTACHMENT

(71) Applicants: Michael O'Brien, Hixson, TN (US); Steve Michael, Hixson, TN (US); Gregory O'Brien, Chattanooga, TN (US)

(72) Inventors: Michael O'Brien, Hixson, TN (US); Steve Michael, Hixson, TN (US); Gregory O'Brien, Chattanooga, TN (US)

(21) Appl. No.: 13/868,094

(22) Filed: Apr. 22, 2013

Related U.S. Application Data
(60) Provisional application No. 61/636,348, filed on Apr. 20, 2012.

(51) Int. Cl. B66C 23/36

(52) U.S. Cl. CPC B66C 23/36
USPC 414/543

(57) ABSTRACT

A hard top removal/placement device permits one person to safely and easily remove or place a hard top off/on a vehicle anywhere the vehicle is located and without requiring additional people for its operation. The device is portable, so it can be carried with the user, in the vehicle, and used anywhere—in a parking lot, at a campsite, at the beach, at the user's home, or the like. The device is compact and lightweight and does not need a structure to be mounted to in order for it to be used. The device can simply attach to their trailer hitch receiver and be ready to use in minutes.

### CROSS-REFERENCE TO RELATED APPLICATION

This application claims the benefit of priority of U.S. provisional application number 61/636,348, filed Apr. 20, 2012, the contents of which are herein incorporated by reference.

### BACKGROUND OF THE INVENTION

The present invention relates to methods and apparatus for removing vehicle hard tops and, more particularly, to a self-contained, portable, one-person hard top hoist that can be carried in the vehicle and used anywhere.

It is very difficult, if not impossible, to remove a hard top from a vehicle, like a Jeep, without the help of one or more people or a stationary device like a hoist mounted in a garage. Most of the time, a person cannot find help or they may not be where the stationary hoist is positioned. Since the hoist is typically ceiling mounted, the vehicles needs to be in a particular location to make use thereof.

As can be seen, there is a need for an apparatus for removing a hard top from a vehicle that can be taken with the user, used virtually anywhere, and can be used to remove the hard top with only a single person.

### SUMMARY OF THE INVENTION

In one aspect of the present invention, a hard top removal/placement device comprises a hitch insert fitting into a receiver hitch of a vehicle; a lower arm extending from the hitch insert; an upper arm attached to the lower arm with a swivel joint assembly permitting the upper arm to swivel relative to the lower arm; a boom extending from the upper arm; a main strap passing through the boom; a winch/motor attached to the main strap, permitting the main strap to extend and retract from an end of the boom; and an attachment mechanism for attaching the main strap to a hard top of the vehicle.

These and other features, aspects and advantages of the present invention will become better understood with reference to the following drawings, description and claims.

### BRIEF DESCRIPTION OF THE DRAWINGS

FIG. 1 is a side view of a hard top removal/placement device, in position for removal of the hard top, according to an exemplary embodiment of the present invention;

FIG. 2 is a side view of the hard top removal/placement device of FIG. 1, illustrating the hard top lifted from the vehicle;

FIG. 3 is a side view of the hard top removal/placement device of FIG. 1, illustrating the hard top being swiveled behind the vehicle;

FIG. 4 is a side view of the hard top removal/placement device of FIG. 1, illustrating the hard top being placed on the ground behind the vehicle;

FIG. 5 is a perspective view of the hard top removal/placement device of FIG. 1, removed from the vehicle;

FIG. 6 is a detailed perspective view of a swivel/hinge joint assembly of the hard top removal/placement device;

FIG. 7 is a detailed perspective view of the swivel/hinge joint assembly of FIG. 6, illustrating swivel action;

FIG. 8 is a detailed perspective view of the swivel/hinge joint assembly of FIG. 6, illustrating hinge action;

FIG. 9 is a detailed perspective view of a winch/motor used in the hard top removal/placement device of FIG. 1;

FIG. 10 is an end perspective view of a boom of the hard top removal/placement device of FIG. 1;

FIG. 11 is a perspective view of the hard top removal/placement device of FIG. 1, illustrated in a compact state; and

FIG. 12 is a perspective view illustrating placement of a footman loop on the hard top of the vehicle.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a hard top removal/placement device that permits one person to safely and easily remove or place a hard top off/on a vehicle anywhere the vehicle is located and without requiring additional people for its operation. The device is portable, so it can be carried with the user, in the vehicle, and used anywhere—in a parking lot, at a campsite, at the beach, at the user's home, or the like. The device is compact and lightweight and does not need a structure to be mounted to in order for it to be used. The device can simply attach to their trailer hitch receiver and be ready to use in minutes.

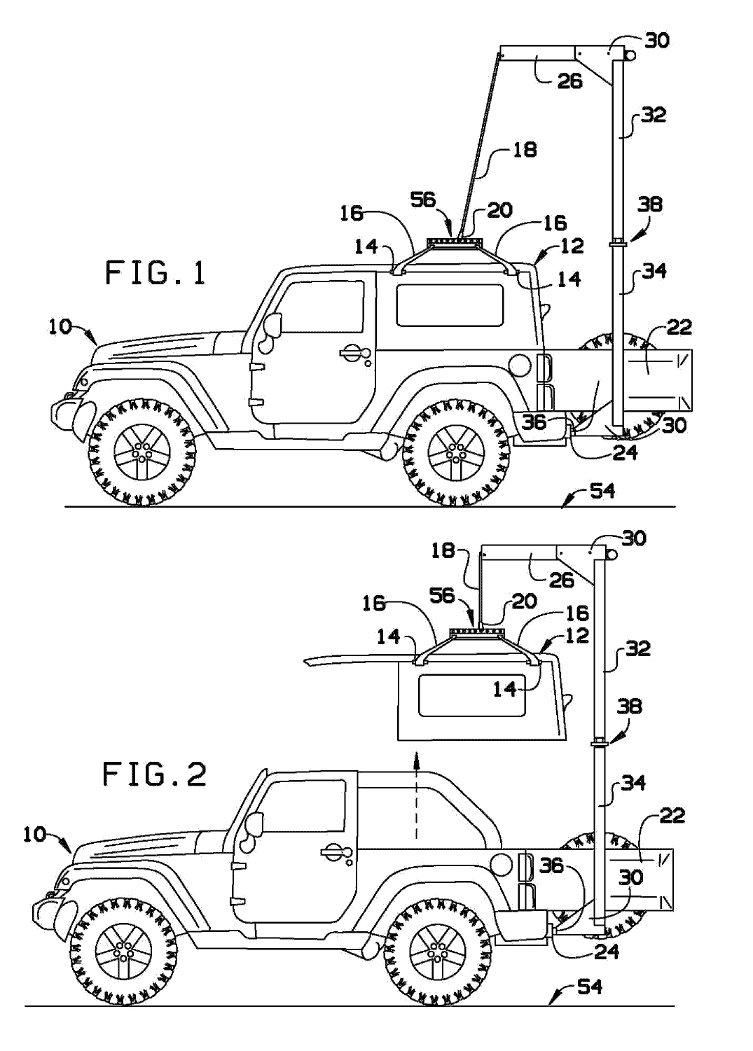

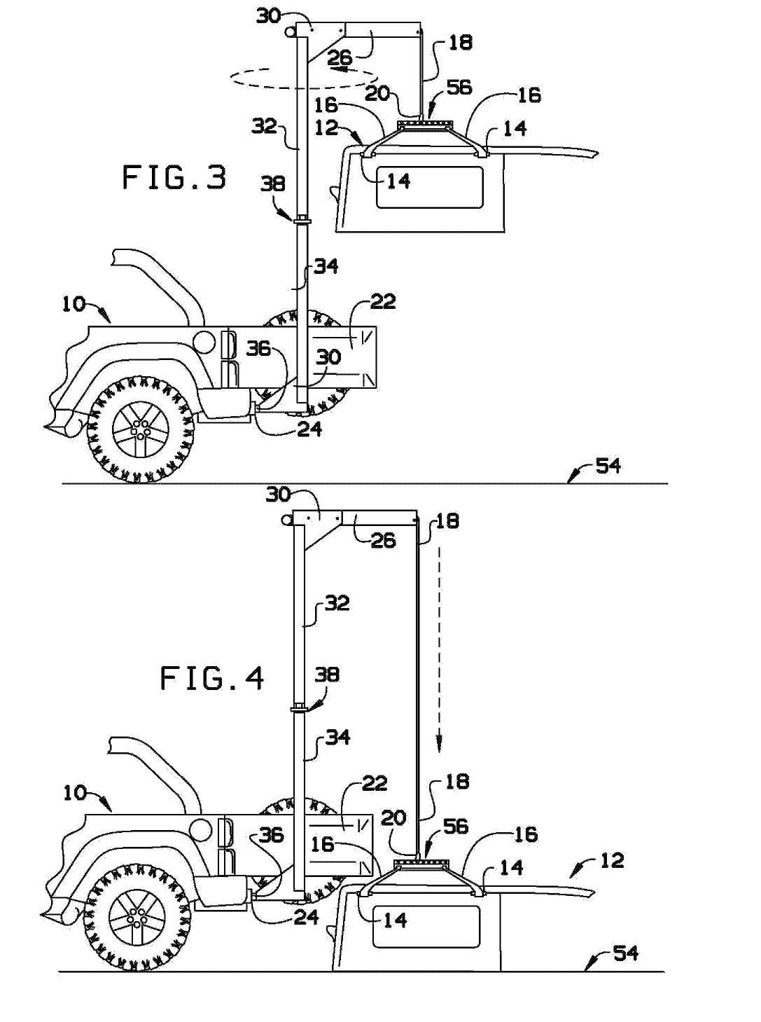

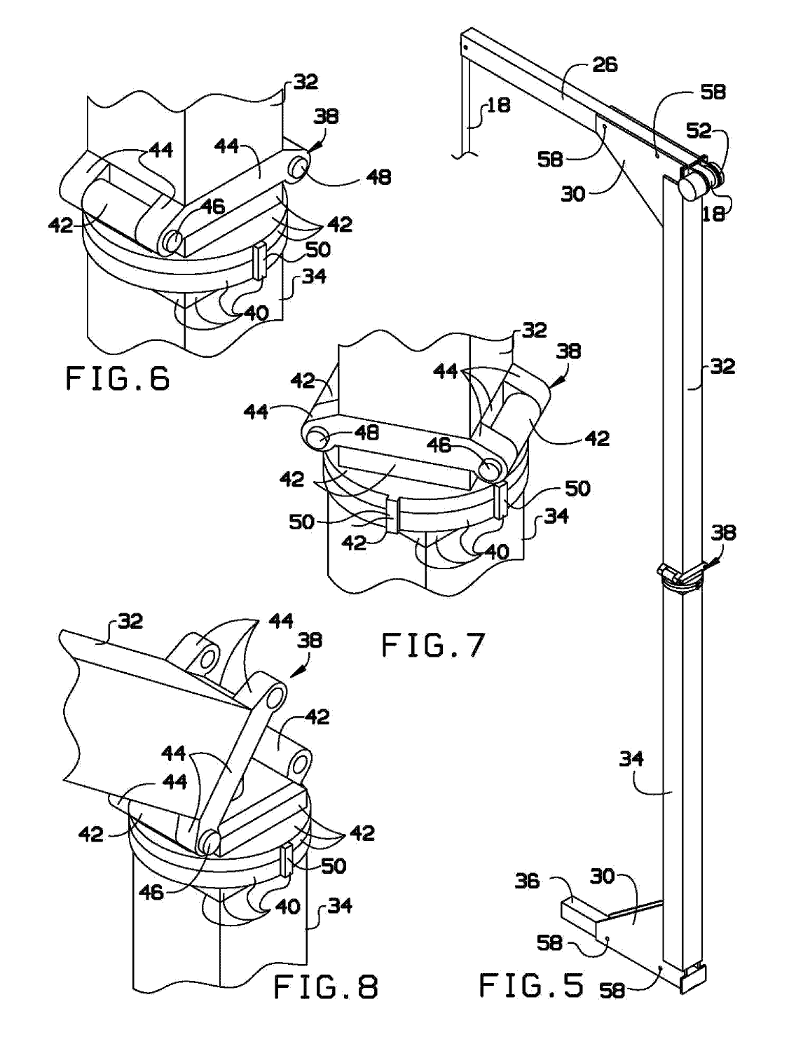

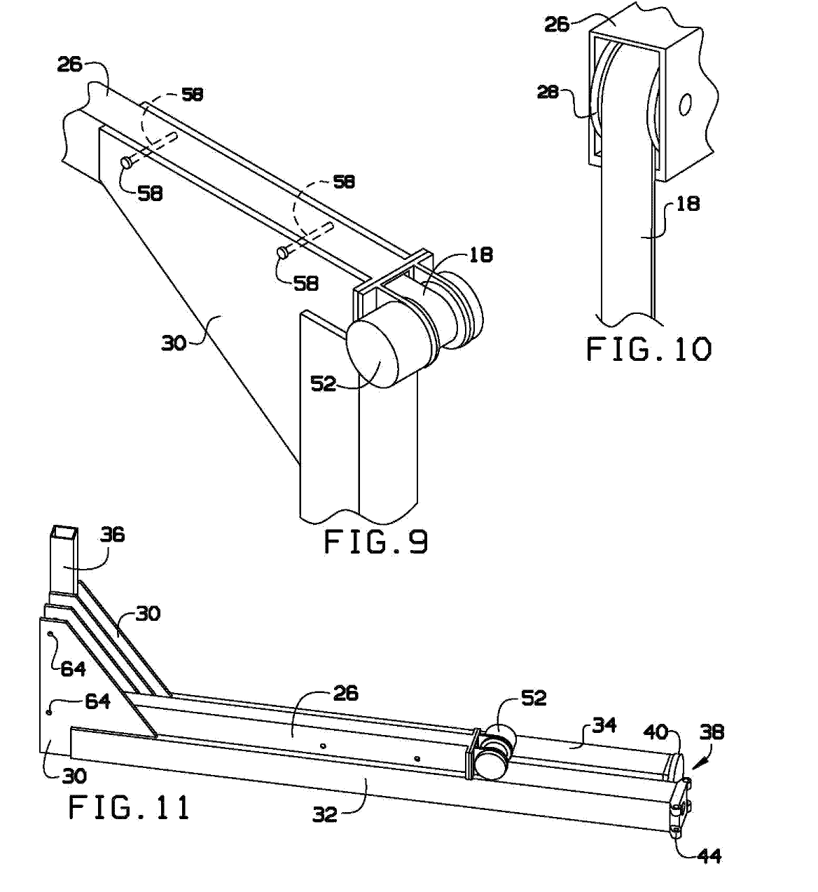

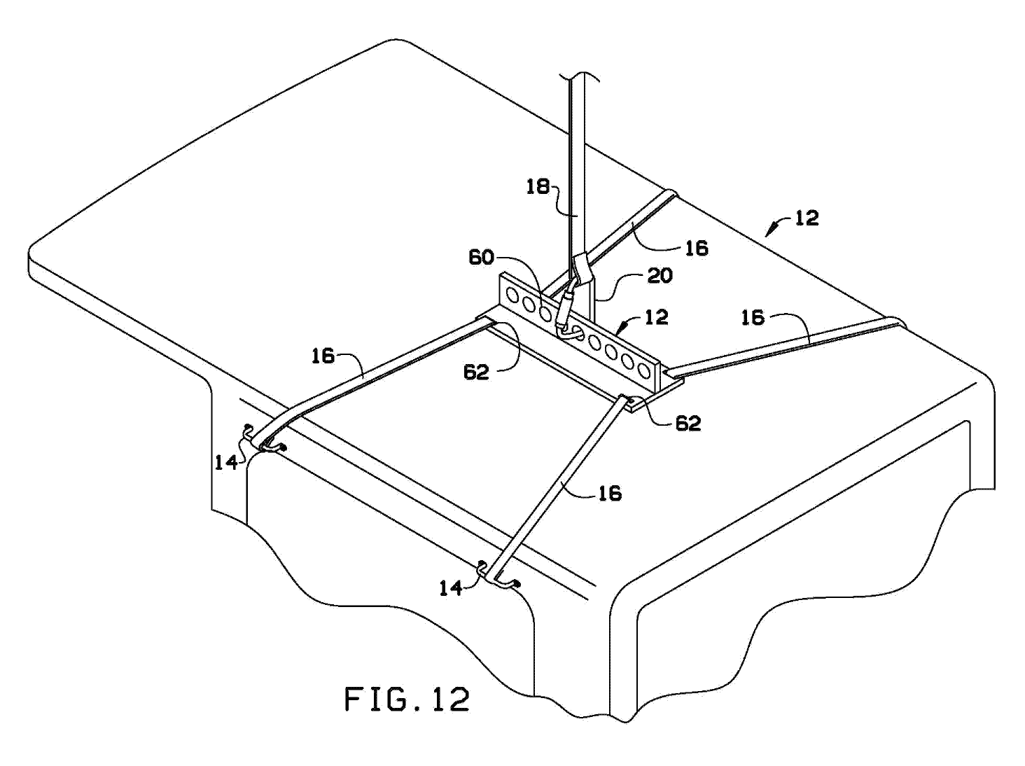

Referring now to FIGS. 1 through 12, a vehicle 10, having a removable hard top 12 typically requires multiple people to place and remove the hard top 12 from the vehicle 10. A hard top removal/placement device can be used, as described below, to safely, quickly and easily allow one person to remove and replace the hard top 12.

A hitch insert 36 can fit into a vehicle receiver hitch 24 and can be locked in place by means known in the art. A lower arm 34 can extend from the hitch insert 36 at an angle generally from about 90 to about 100 degrees. Angled brackets 36 can extend from the lower arm 34 and removably connect to the hitch insert 36 to provide support between the connection of the hitch insert 36 and the lower arm 34. In some embodiments, the hitch insert 36 can be removed through the use of angled bracket pins 58 fitting through the angled brackets 36 and into the hitch insert 36.

An upper arm 32 can connect to the lower arm 34. A swivel/hinge joint assembly 38 can be used to connect the upper arm 32 with the lower arm 34 so that the upper arm 32 can swivel on the lower arm 34. A lower swivel bracket 40 can connect to the lower arm 34 and an upper swivel and hinge bracket 42 can be attached to the upper arm 32. A swivel stop 50 can be disposed to prevent swiveling of the upper arm 32 beyond about 360 degrees. A hinge bracket 44 can attach to a pivot pin 46 to permit the upper arm 32 to pivot about an axis of the pivot pin 46. A lock pin 48 can be removably inserted into the hinge bracket 44, opposite the pivot pin 46. The lock pin 48 can be used to prevent the upper arm from pivoting on the pivot pin 46 during use. To fold into a compact state (as shown in FIG. 11), a user can remove the lock pin 48 to allow the upper arm 32 to fold alongside the lower arm 34.

A boom 26 can extend from the upper arm 32 at about a 90 degree angle. Angled brackets 30 can be used to attach the boom 26 to the upper arm 32. The angled brackets 32 can have angled bracket pins 58 that fit through holes 64 in the angled brackets 30 and the boom 26 to removably secure the boom 26 in place.

A winch/motor 52 can be positioned, for example, at the end of the boom 26 where the boom 26 attaches to the upper arm 32. A main strap 18 can extend from the winch/motor 52, out through the boom 26, about a pulley 28 and out of the boom 26 in a direction toward the hard top 12. The winch/motor 52 can be powered from various sources, such as a vehicle hitch power supply, a separate circuit ran from the vehicle battery, a separate battery, or the like.

The main strap 18 can be used to connect to the hard top 12. Various methods can be used. In one embodiment, as best shown in FIG. 12, the main strap 18 can terminate with a carabineer 20 that can be attached into a hole 60 in a T-bar 56 to balance any top. Slots 62 can be cut in each end of the T-bar 56 and support straps 16 can run through the slots 62 and terminate with a footman loop 14 that is attached to the hard top 12. This design permits a four-point attachment of the main strap 18 to the hard top 12.

To use the hard top removal/placement device of the present invention, a user can simply attach the support straps 16/footman loops 14 to the hard top 12. The hitch insert 36 can be placed in the vehicle receiver hitch 24 after the vehicle gate 22 is opened. The user can turn on the winch/motor 52 to cause the main strap 18 to pull the hard top 12 up and off the vehicle 10. The user can simply push on the hard top 12 to cause it to swivel and move the hard top 12 to a desired position. The user then reverses the direction of the winch/motor 52 to lower the hard top 12 to the ground 54. To replace the hard top, the user simply reverses this process.

While the drawings show the motor/winch 52 at the end of the boom 26, the winch/motor could be disposed along the length of the upper arm 32, the lower arm 34 or at the base of the lower arm 34. If this is the case, an additional pulley can be disposed at the end of the boom 26 to direct the main strap 18 down toward the ground.

While the above describes using the device of the present invention to place and remove hard tops on vehicles, there are other uses of the device of the present invention. For example, the device can be used to lift and/or move items in and out of a pickup truck bed.

It should be understood, of course, that the foregoing relates to exemplary embodiments of the invention and that modifications may be made without departing from the spirit and scope of the invention as set forth in the following claims.

What is claimed is:

1. A hard top removal/placement device comprising:
a hitch insert fitting into a receiver hitch of a vehicle;
a lower arm extending from the hitch insert;
an upper arm attached to the lower arm with a swivel joint assembly permitting the upper arm to swivel relative to the lower arm;
a boom extending from the upper arm;
a main strap passing through the boom;
a winch/motor attached to the main strap, permitting the main strap to extend and retract from an end of the boom; and
an attachment mechanism for attaching the main strap to a hard top of the vehicle.

2. The hard top removal/placement device of claim 1, wherein the lower arm extends from the hitch insert at an angle from about 90 to about 100 degrees.

3. The hard top removal/placement device of claim 1, further comprising an angled bracket extending from the lower arm and removably connecting to the hitch insert with angled bracket pins.

4. The hard top removal/placement device of claim 1, further comprising an angled bracket extending from the upper arm and removably connecting to the boom with angled bracket pins.

5. The hard top removal/placement device of claim 1, wherein the winch/motor is attached to a first end of the boom, the first end being opposite a second end from the boom from which the main strap extends.

6. The hard top removal/placement device of claim 1, further comprising a pulley at an end of the boom from which the main strap passes over and extends.

7. The hard top removal/placement device of claim 1, wherein the attachment mechanism includes a T-bar attached to the main strap, the T-bar having slots formed in each end thereof, wherein support straps pass through the T-bar and connect to the hard top.

8. The hard top removal/placement device of claim 7, further comprising footman loops disposed at ends of the support straps.

9. The hard top removal/placement device of claim 1, where the swivel joint assembly includes a hinge joint assembly for hingedly connecting the upper arm to the lower arm.

10. The hard top removal/placement device of claim 1, further comprising a swivel stop on the swivel joint assembly, the swivel stop limiting the amount of swivel between the upper arm and the lower arm.
